(19) United States
(12) Patent Application Publication
(10) Pub. No.: US 2024/0330734 A1
(43) Pub. Date: Oct. 3, 2024

(54) HYBRID QUANTUM SENSORS BASED ON SPIN DEFECTS COUPLED TO AN ARRAY OF SINGLE MOLECULE MAGNETIC CENTERS

(71) Applicants: Honda Motor Co., Ltd., Tokyo (JP); MASSACHUSETTS INSTITUTE OF TECHNOLOGY, Cambride, MA (US)

(72) Inventors: Avetik HARUTYUNYAN, Santa Clara, CA (US); Xufan Li, Fremont, CA (US); Paola Cappellaro, Cambridge, MA (US)

(21) Appl. No.: 18/622,452

(22) Filed: Mar. 29, 2024

Related U.S. Application Data
(60) Provisional application No. 63/493,371, filed on Mar. 31, 2023.

(51) Int. Cl. G06N 10/40; B82Y 10/00

(52) U.S. Cl. CPC G06N 10/40; B82Y 10/00

(57) ABSTRACT

Hybrid quantum sensors are provided. In some aspects, a hybrid quantum sensor comprises a first layer of diamond having multiple nitrogen-vacancy defect centers; and a second layer overlaying the first layer. The second layer forms a planar interface with the first layer, and includes at least one paramagnetic metal phthalocyanine. The at least one paramagnetic metal phthalocyanine comprises at least one transition metal.

### CROSS-REFERENCE TO RELATED APPLICATIONS

This application claims the benefit of and priority to U.S. Patent Application No. 63/493,371, filed on Mar. 31, 2023, the contents of which application are hereby expressly incorporated by reference herein in their entireties.

### TECHNICAL FIELD

The present disclosure is directed to hybrid quantum sensors.

### BACKGROUND

Recent practical demonstrations of quantum sensors and the feasibility of quantum computing have resulted in much interest in the field of quantum science and technology. The key building block for many developments in this field is the qubit, the quantum analog of the classical bit.

Optically active electronic spin defects are an ideal platform for many applications that exploit quantum phenomena. For example, diamond is an ideal spin qubit host material. Negatively charged Nitrogen-Vacancy (NV) defects in diamond show an electron paramagnetic ground and optically excited state. In each defect, a nitrogen atom with a neighboring vacancy substitute for two carbon atoms in the diamond lattice. As a result, NV single defect hosts a spin triplet electronic ground state that can be polarized, manipulated and optically detected. These atom-like defects in diamond are a good platform for quantum applications, as their quantum properties can be manipulated at room temperature, avoiding the need for costly and heavy cryogenic cooling equipment. Similar systems in other substrate materials and including other types of localized spin defects have shown similar properties or could be developed to achieve even better performance.

Research has suggested that the quantum properties of optically active electronic spin defects are extremely sensitive to magnetic fields. As such, spin defects are ideal for highly sensitive magnetometers. For example, nitrogen-vacancy centers in diamonds have attracted attention as magnetic field sensors with high spatial resolution and sensitivity as low as the sub-picotesla (pT) level for AC fields. The range of their application includes, but is not limited to, single neuron-action potential detection, single protein spectroscopy, and in vivo thermometry. Nitrogen-vacancy center diamonds have also demonstrated relatively long decoherence times and wide vector functionality.

However, despite these advantages, spin defects in bulk material substrates also pose several challenges, including controlling the depth of the spin defects from the surface of the material substrate, controlling the density of the desired spin defects, reducing the presence of other, deleterious defects, fabricating regular arrays of desired spin defects or desirable configurations, and scaling up and ruggedize the sensor platform. As such, there is a need in the art for quantum sensors that address these challenges.

### SUMMARY

The present disclosure is directed to a hybrid quantum sensor having a first component and a second component, the first component including an electronic spin defect in a bulk material substrate (hereinafter generically referred to as “NVD,” after the exemplary nitrogen-vacancy center in diamond) and the second component including an organic semiconductor configured to host molecular spin qubits. According to some aspects, an electronic spin of the first component is coupled with an electronic spin of the second component. Also disclosed are methods of making and using the sensors as described herein.

### BRIEF DESCRIPTION OF THE DRAWINGS

FIG. 1 shows an example NVD as described herein.

FIG. 2 shows an example schematic diagram of the energy levels of an NVD.

FIG. 3 shows a schematic of an example hybrid quantum sensor as described herein.

FIG. 4 shows an example schematic of quantum entanglement as described herein.

FIG. 5 shows a schematic sideview of an example hybrid quantum sensor as described herein.

FIG. 6A shows a first example of a system to implement a vertical physical vapor deposition (PVD) process to form hybrid quantum sensors in accordance with aspects described herein.

FIG. 6B shows a second example of a system to implement a vertical PVD process to form hybrid quantum sensors, including a shutter and a mask, in accordance with aspects described herein.

FIG. 7 shows another example of a system to implement a horizontal PVD process to form hybrid quantum sensors in accordance with aspects of this disclosure.

FIG. 8 shows a typical optical image of a diamond substrate covered with CuPc thin film, in accordance with aspects described herein.

FIG. 9A shows an atomic force microscopy (AFM) image of the diamond surface as described in Example I.

FIG. 9B shows the AFM topography profile of the diamond surface as described in Example I.

FIG. 10A shows an AFM image of the CuPc surface on diamond as described in Example I.

FIG. 10B shows the AFM topography profile of the CuPc surface on diamond as described in Example I.

FIG. 10C shows an enlarged view of the AFM image shown in FIG. 10A.

FIG. 11A shows the Raman spectrum of the hybrid quantum sensor as described in Example II.

FIG. 11B shows an enlarged view of the spectrum of FIG. 11A from 50 to 500 cm⁻¹.

FIG. 11C shows a confocal image of the hybrid quantum sensor as described in Example II.

FIG. 11D shows a confocal image of a diamond sample.

FIG. 12 shows a diagram of T2 coherence times measured using a spin echo pulse sequence.

FIG. 13 shows the pulse mapping as described in Example II.

FIG. 14 shows the decay curve as described in Example II.

### DETAILED DESCRIPTION

The present disclosure is directed to a hybrid quantum sensor having a first component and a second component, the first component including an NVD and the second component including an organic semiconductor configured to host molecular spin qubits. According to some aspects, an electronic spin of the first component is coupled with an electronic spin of the second component. Also disclosed are methods of making and using the sensors as described herein.

The hybrid quantum sensor of the present disclosure includes a first component that forms or constitutes an NVD. As used herein, an NVD refers to a material substrate having at least one stable, optically active electronic spin defect (e.g., diamond having at least one negatively charged nitrogen vacancy (NV) center. The NV center is an optically active point defect that includes a nitrogen atom adjacent to a lattice vacancy with an additional electron. These point defects can be created during diamond growth or engineered by nitrogen ion implantation followed by annealing (with an optional stage of electron irradiation). Single defects (separated by more than a few hundred nanometers) can be seen using a confocal microscope. High density of defects can also be created, and the density of those defects about 10¹⁷ cm⁻³ as a threshold level (approximately 0.6 ppm) can be evaluated from the intensity of emitted fluorescence light. An increasing concentration of NV centers over about 5×10¹⁸ cm⁻³ (or 5.6 ppm) leads to a decrease in their dephasing and coherence times. Below 10¹⁷ cm⁻³ concentration level, isotope of ¹³C (natural abundance ˜1%) becomes the major impurity unless an isotopically pure diamond is used. Similar combinations of material substrates (e.g., oxides or semiconductors with large bandgap that allows stable point defects, such as SiC, ZnO, CeO, silicon, etc.) and optically active spin defects (such as NV in diamond, SiV in diamond and SiC, Sn—Li in ZnO, etc.) can be created in many other materials with similar fabrication processes and density. The properties of such optically active defects enable optical initialization, microwave coherent quantum control, and optical readout, as is described herein.

For purposes of illustration, aspects of the hybrid quantum sensor of the present disclosure are described with reference to an NV center system. The present disclosure, however, is not limited in that respect.

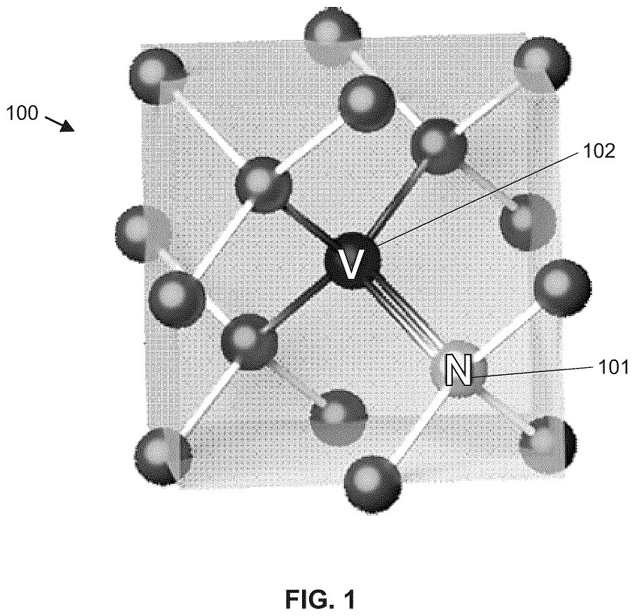

FIG. 1 shows an example NV center in the diamond lattice. In particular, FIG. 1 shows a diamond lattice 100 wherein at least one carbon atom is substituted by a nitrogen atom 101 being adjacent to a carbon vacancy 102.

As known in the art, each NV center includes a number of electrons including three unpaired electrons, each one from the vacancy to a respective of the three carbon atoms adjacent to the vacancy, and a pair of electrons between the nitrogen and the vacancy. The NV center, which is in the negatively charged state, also includes an extra electron.

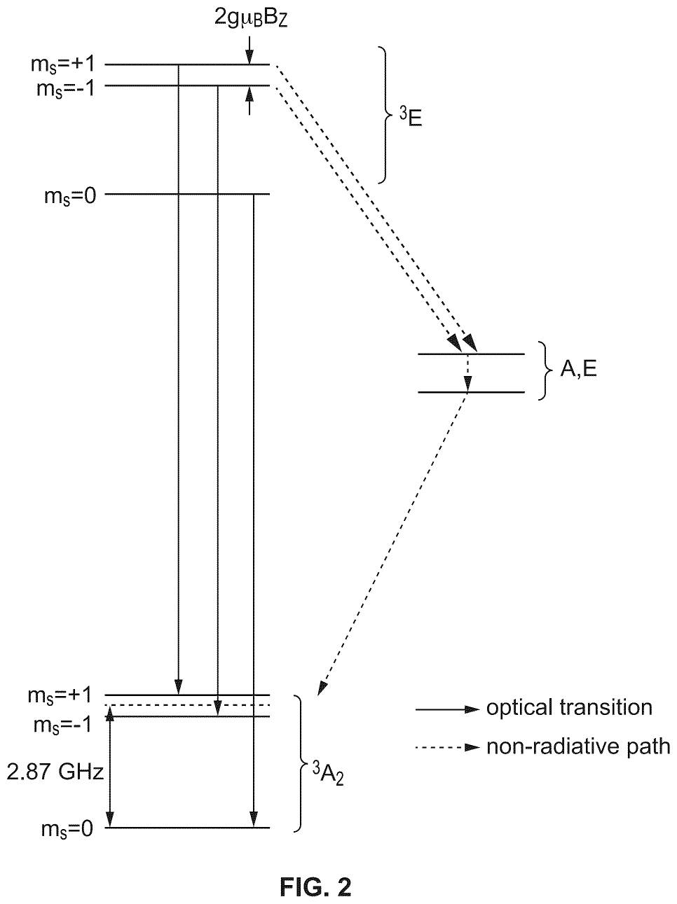

The NV center has rotational symmetry. In particular, as shown in FIG. 2, the NV center includes a ground state, which is a spin triplet with ³A₂ symmetry with one spin state mₛ=0, and two further spin states mₛ=±1 and mₛ=−1. In the absence of an external magnetic field, the mₛ=±1 energy levels are offset from the mₛ=0 due to spin-spin interactions, and the mₛ=±1 energy levels are degenerate, i.e., they have the same energy. The mₛ=0 spin state energy level is split from the mₛ=+1 energy levels by an energy of 2.87 GHz in a zero external magnetic field, as shown in FIG. 2.

As shown in FIG. 2, introducing an external magnetic field with a component along the NV axis lifts the degeneracy of the mₛ=+1 energy levels, splitting the energy levels mₛ=±1 by an amount 2 gμ_{B}B_{z}, where g is the g-factor, μ_{B} is the Bohr magneton, and B_{z} is the component of the external magnetic field along the NV axis.

As shown in FIG. 2, the NV center further includes an excited triplet state 3E with corresponding mₛ=0 and mₛ=±1 spin states. The optical transitions between the ground state ³A₂ and the excited triplet ³E are predominantly spin conserving, i.e., the optical transitions are between initial and final states which have the same spin. For a direct transition between the excited triplet ³E and the ground state ³A₂, a photon of red light is emitted with a photon energy corresponding to the energy difference between the energy levels of the transitions.

As shown in FIG. 2, an alternate non-radiative decay route from the triplet 3E to the ground state ³A₂ via intermediate electron states also exists, which are thought to be intermediate singlet states A, E with intermediate energy levels. Notably, the transition rate from the mₛ=+1 spin states of the excited triplet 3E to the intermediate energy levels is significantly greater than the transition rate from the mₛ=0 spin state of the excited triplet ³E to the intermediate energy levels. The transition from the singlet states A, E to the ground state triplet ³A₂ predominantly decays to the mₛ=0 spin state over the mₛ=+1 spin states. These features of the decay from the excited triplet 3E state via the intermediate singlet states A, E to the ground state triplet ³A₂ allows that if optical excitation is provided to the system, the optical excitation will eventually pump the NV center into the mₛ=0 spin state of the ground state ³A₂. In this way, the population of the mₛ=0 spin state of the ground state ³A₂ may be “reset” to a maximum polarization determined by the decay rates from the triplet 3E to the intermediate singlet states and the ground state thermal relaxation time.

As known in the art, the fluorescence intensity due to optically stimulating the excited triplet ³E state is less for the mₛ=±1 states than for the mₛ=0 spin state due to the decay via the intermediate states not resulting in a photon emitted in the fluorescence band in addition to the greater probability that the mₛ=±1 states of the excited triplet ³E state will decay via the non-radiative decay path. The lower fluorescence intensity for the mₛ=±1 states than for the mₛ=0 spin state allows the fluorescence intensity to be used to determine the spin state at room temperature. When the spin in a superposition state and/or the population of the mₛ=±1 states is higher relative to the mₛ=0 spin, the overall fluorescence intensity can be reduced.

The hybrid quantum sensor of the present disclosure further includes a second component having an organic semiconductor configured to host molecular spin qubits. According to some aspects, the organic semiconductor includes a metal phthalocyanine (MPc). According to other aspects, the organic semiconductor includes metallorganic molecules with non-zero magnetic moment.

As used herein, the term metal phthalocyanine, or MPc, refers to a complex of a metal and a phthalocyanine. As known in the art, a phthalocyanine is an aromatic, macrocyclic, organic compound having the formula (C₈H₄N₂)₄H₂, as shown in formula I:

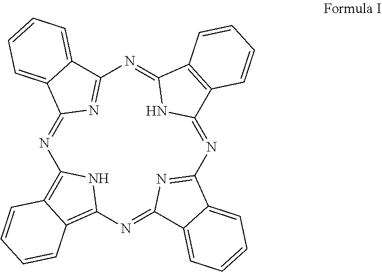 [SMILES: c1ccc2c(c1)-c1nc-2nc2[nH]c(nc3nc(nc4[nH]c(n1)c1ccccc41)-c1ccccc1-3)c1ccccc21]

The MPc according to the present disclosure has a formula as shown in Formula II:

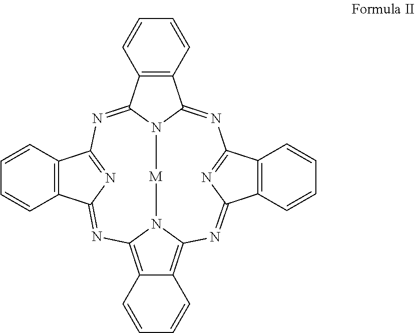

wherein M is a metal.

According to some aspects, the metal includes a transition metal, such as a 3d transition metal, a 4d transition metal, or a combination thereof. Example 3d transition metals include Sc, Ti, V, Cr, Mn, Fe, Co, Ni, Cu, and Zn. Example 4d transition metals include Y, Zr, Nb, Mo, Tc, Ru, Rh, Pd, Ag, and Cd. In some preferred aspects, the MPc may include CuPc, CoPc, VOPc, or a combination thereof.

According to some aspects, the organic semiconductor may include one or more metal phthalocyanines. The metal phthalocyanine(s) can be paramagnetic or ferromagnetic, or a combination thereof. In some cases, the organic semiconductor may further include one or more secondary materials. Example secondary materials include, but are not limited to, non-metal materials such as metal-free phthalocyanines, diamagnetic materials such as a diamagnetic MPc, and combinations thereof.

According to some aspects, the organic semiconductor may include paramagnetic MPc(s) and secondary material(s) at a weight ratio between about 1:1000 and 1; optionally between 1:500 and 500:1; optionally between about 1:200 and 200:1, optionally between about 1:100 and 100:1, optionally between about 1:50 and 50:1, optionally between about 1:10 and 10:1, optionally between about 1:5 and 5:1, optionally between about 1:2 and 2:1, and optionally about 1:1. The disclosure is not limited in that respect and other weight ratios can be utilized.

According to some aspects, the first component and/or the second component may be provided as a film. As used herein, the term “film” refers to a material having a thickness in a range from about 1 nm to about hundreds of nanometers. In one example, the thickness can range from about 1 nm to about 200 nm, optionally between about 1 and 100 nm, optionally between about 1 and 50 nm, optionally between about 20 and 30 nm, optionally about 25 nm, and optionally about 20 nm. Accordingly, the second component can have a thickness in a range from about a single layer of MPc to about 200 nm, optionally from about a single layer of MPc to about 100 nm, optionally between about 1 and 50 nm, optionally between about 20 and 30 nm, optionally about 25 nm, and optionally about 20 nm. The thickness may be substantially uniform. As used herein, “substantially” or “about” should be understood as being within ±5% of the stated value, optionally within ±1%.

According to some aspects, the first component and/or the second component may have a certain roughness. As used herein, the term “roughness” refers to the average deviation from the mean line. According to some aspects, the second component may have a roughness between about 0.5 to 1.5 nm, optionally about 0.5 nm, optionally about 0.6 nm, optionally about 0.7 nm, optionally about 0.8 nm, optionally about 0.9 nm, optionally about 1.0 nm, optionally about 1.1 nm, optionally about 1.2 nm, optionally about 1.3 nm, optionally about 1.4 nm, and optionally about 1.5 nm.

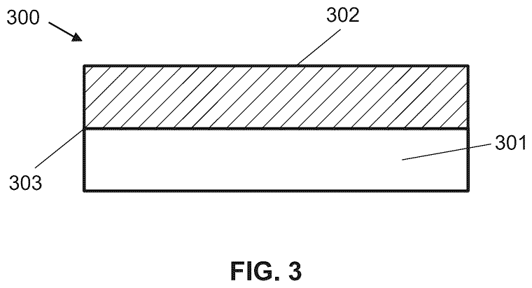

FIG. 3 shows a schematic diagram of an example hybrid quantum sensor as described herein. In particular, FIG. 3 shows a hybrid quantum sensor 300 having a first component 301 and a second component 302. In some cases, the first component 301 can be embodied on a substrate of a material including NVD centers. In other cases, the first component 301 can overlay a planar surface of such a substrate. For example, the first component can be formed on the planar surface of the substrate by using evaporation techniques, e.g., CVD, epitaxial techniques (such as molecular beam epitaxy (MBE) techniques), sputtering, or other similar deposition techniques. Thus, a slab of a substrate forms the first component 301, or a layer deposited onto the substrate forms the first component 301. As mentioned, the second component 302 can formed by an MPc or, in some case, by a mixture of two or more metal phthalocyanine (e.g., CuPc and NiPc). As shown in FIG. 3, second component 302 may be provided as a film on a surface 303 of first component 301. In this way, first component 301 and second component 302 may be coupled quantum mechanically via electronic spin-spin interaction. That is, an unpaired electron spin in a metal atom in the second component 302 and an electron spin in the NVD of the first component 301 can become quantum mechanically entangled. In some cases, the spin-spin interaction (e.g., magnetic dipolar coupling) can be used to create correlations between the two spins, transferring polarization and/or information about the metal atom spin state in the second component 302 to the defect electronic spin in the first component 301 or vice versa.

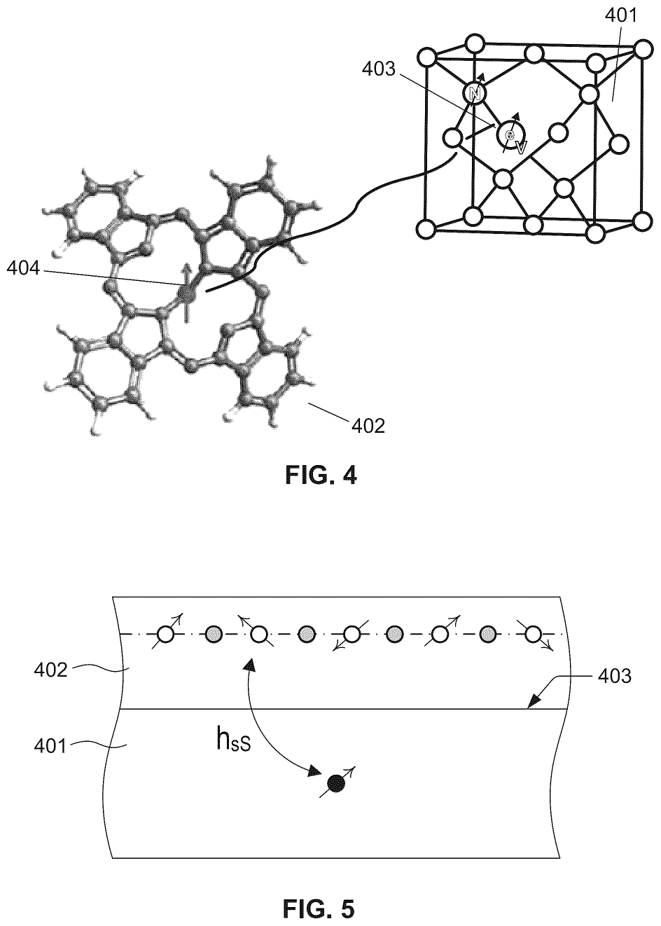

For example, FIG. 4 shows an example schematic diagram of quantum interaction as described herein. In particular, FIG. 4 shows a section of a second component 401 including an NVD and a section of a first component 402 having an MPc (individually or diluted by another MPc) as described herein. As shown in FIG. 4, the electronic spin of a metal ion 404 of first component 402 (S=1/2) is coupled with the spin of an NVD center 403 of second component 401 (S=1). Such a spin-spin interaction permits detection of magnetic fields in hybrid sensors in accordance with this disclosure. The first component 402 can coat a substrate or a film that embodies the second component 401, thus forming an interface with the second component 401.

Unpaired electron spins of respective metal atoms of MPc molecules that form the first component 402 can interact with one another via spin-spin interaction. In this way, second component 402 acts as a spin bath. Spin-spin interaction between an unpaired electron spin in the first component 402 and an electron spin in an NVD defect center in the second component 401 is desirable in the technologies described herein. In contrast, the spin bath formed in the first component 402 can cause spin decoherence within the first component 402. An approach to mitigate such decoherence is to form the first component 402 from a mixture of metal phthalocyanine. Simply as an illustration, the first component 402 can be formed from CuPc and NiPc. Because CuPc and NiPc are isomorphic, diluting CuPc with NiPc can result in a material having the atomic structure of CuPc but with greater Cu—Cu distances than in the CuPc. In other words, as is schematically depicted in FIG. 5, Ni atoms (represented by grey circles) can separate Cu atoms (represented by hollow circle). Such an increased Cu—Cu distance in combination with Ni being diamagnetic can result in a reduced interaction between unpaired electronic spins (depicted by arrows) localized in respective Cu atoms, since the interaction intensity decreases with the third power of the distance. Hence, coherence time of electronic spins in the resulting CuPc: NiPc compound can be increased relative to CuPc. That is, decoherence arising from the spin-bath formed by the electronic spin-spin interaction among Cu atoms can be reduced, thus increasing the sensitivity of a magnetometer based on the sensors in accordance with this disclosure.

Further, unpaired electronic spins of the metal atom in MPc can interact, via hyperfine magnetic coupling, with nuclear spins (I=1) of surrounding nitrogen atoms (see Formula II above). Similarly, interaction between an unpaired electronic spin of the metal atom and nuclear spins (I=1/2) of hydrogen atoms in a molecule of MPc also can cause decoherence. An approach to mitigate such decoherence can include forming a compound where hydrogen atoms are replaced with deuterium, which has smaller magnetic dipole.

Interactions between the spin bath and an environment or other elements of the first component 402 also can increase decoherence. An approach to mitigate such interactions can include the application of dynamical decoupling techniques. In such an approach, a time-dependent electromagnetic perturbation can be externally applied to the spin bath, where the perturbation can at least partially cancel the effect of such interactions. More specifically, the time-dependent electromagnetic perturbation can be a periodic electromagnetic (EM) waveform with a frequency that is the same or similar to a frequency derived from a characteristic energy of the spins (e.g., a microwave drive waveform). The periodic EM waveform can include periodic short burst of an EM field implementing π rotations of spins. The π rotations can flip the sign of spin-spin interactions, which can thus be modulated by a ±1 (periodic) sign and therefore average out to zero or to a value that is approximately zero. By compensating for such undesirable interactions, decoherence can be mitigated. It is noted that other waveforms besides periodic waveforms also can be applied. Time-dependent electromagnetic perturbations include, for example, Walsh sequences and Carr-Purcell-Meiboom-Gill (CPMG) sequences to cancel interactions to nuclear spins. Time-dependent electromagnetic perturbations also can include other sequences such as Wahuha sequences and Mrev8 sequences to cancel interactions among like spins (e.g., electron-electron interactions).

The dynamical decoupling sequences can be designed such that only undesired coupling (e.g., to nuclear spins) are canceled, while preserving desired magnetic dipolar interaction between the metal spins in phthalocyanine and defect electronic spins in NVD. For example, simultaneous control on both the NVD spin and the metal spin leaves their coupling effect intact, while canceling the coupling to nuclear spins. This is enabled by the fact that the characteristic energy of the NVD spin, setting the perturbation frequency for control is distinct from the energy of the metal spins in phthalocyanine, allowing for precise and independent control.

In sharp contrast to conventional technologies such as NMR and EPR, the hybrid quantum sensor of this disclosure permits optical control and detection by probing the NVD component in the presence of the metal phthalocyanine-based component. Additionally, not only can spin density in a hybrid quantum sensor be readily controlled during fabrication, but the fabrication is compatible with existing thin-film technologies and also with plastic electronics and optoelectronics. Ultimately, by integrating an NVD component and a metal phthalocyanine-based component, hybrid quantum sensors of this disclosure can provide substantial sensitivity with microwave control and optical initialization and detection.

The present disclosure is also directed to methods of using the hybrid quantum sensors as described herein to measure a magnetic field. The method may include providing a hybrid quantum sensor having a first component formed from a one or more metal phthalocyanines and also having a second component formed from a material with optically active electronic spin defects (such as the NV center in diamond). As mentioned, in some cases, the first component can be formed from an organic semiconductor that includes metallorganic molecules with non-zero magnetic moment. The method also may include using the second component as a two-state quantum mechanical system by applying an external, uniform magnetic field to the hybrid quantum sensor that enables selective control of two of the defect spin levels associated (e.g., mₛ=0, mₛ=1, and mₛ=1 for the NV defect center; FIG. 2). The method may further include exciting the two-state quantum mechanical system optically with a laser source (e.g., a CW laser beam) in the presence of a target magnetic field to be detected. The target magnetic field can be time-dependent and/or non-uniform. The spin system formed by the first component can temporally evolve in response to the target external magnetic field. Additionally, these spins are quantum-mechanically coupled with the NVD electron spin and can change the evolution and final state of the NVD spin. Thus, the method can include sensing the magnitude of the target external magnetic field by measuring photoluminescence from the second component. That is, photoluminescence from the NVD defect centers that are present in the second component carries information about the target magnetic field felt by the spins in the first component.

In some cases, the spins of the first component may be rotated out of their equilibrium state by the presence of a target magnetic field, and can start precessing at a frequency set by the target magnetic field and the internal energy of the spins. The electronic spin in the second component can then sense this spin precession via the coupling of the NVD spin and the first component spin. For example, the spin state of an NV center in diamond can change from its mₛ=0 spin state (FIG. 2) toward the mₛ=±1 spin (FIG. 2) and correspondingly the photoluminescence intensity can decrease.

The small thickness of the first component (nanoscale films as indicated in [0045]) enhance the effects of external magnetic field by its ability to be brought in nanoscale contact with a dipolar magnetic field to be sensed. The perturbation indicated above is thus enhanced with respect to non-hybrid sensors.

The regular crystal of the thin film molecular system enables the regular positioning of the first component spin sensors, thus potentially enabling high spatial-resolution imaging. This is in contrast with the disordered position of non-hybrid sensors.

The present disclosure is also directed to methods of making a device, and in particular, a hybrid quantum sensor as described herein.

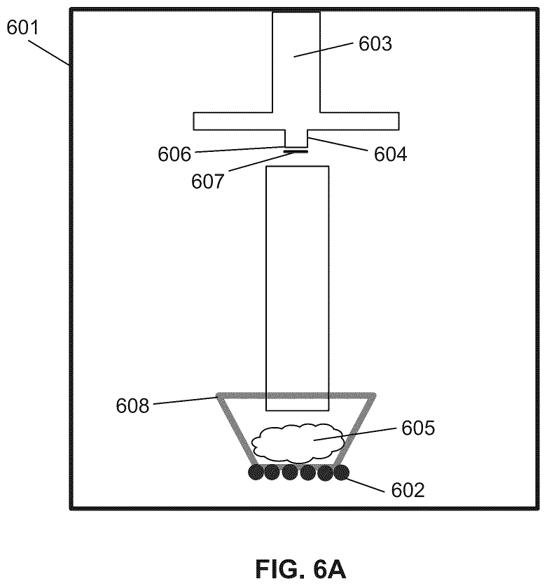

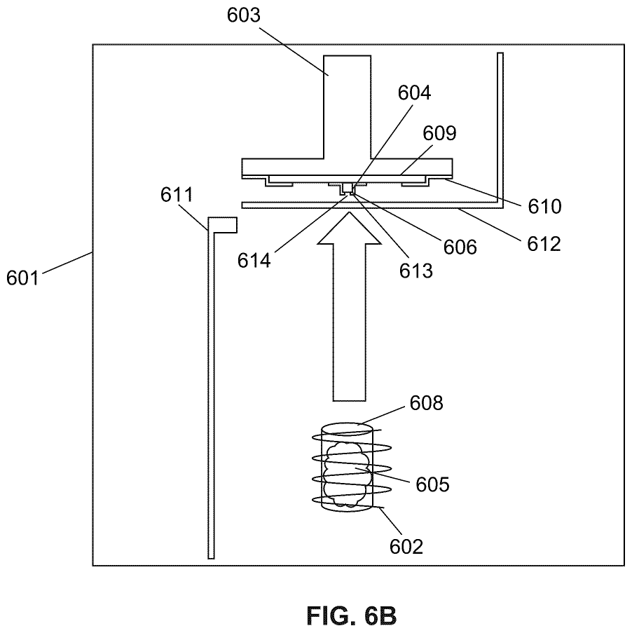

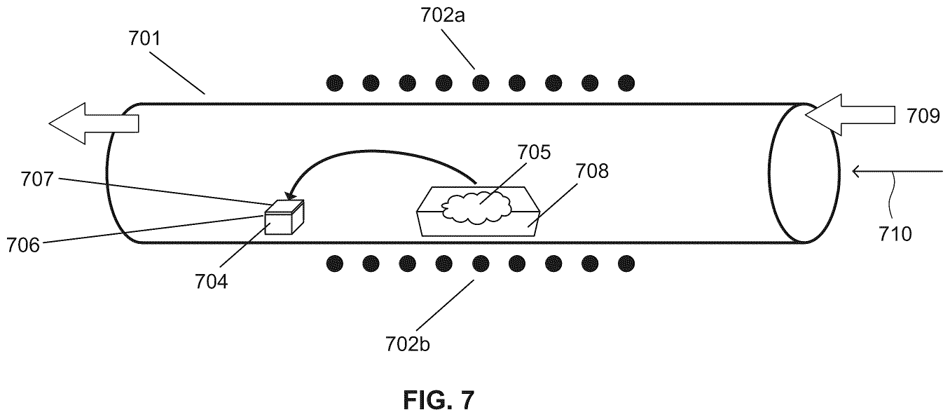

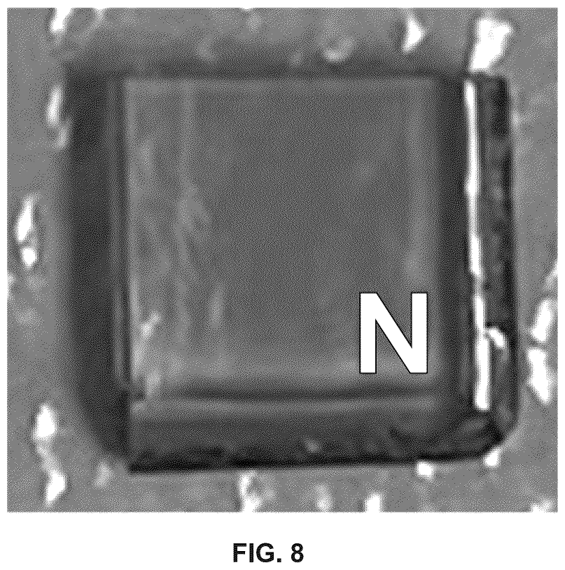

The hybrid quantum sensors comprise a substrate (e.g., diamond substrate) containing the NVD centers (second component) and a thin film of the first component (MPc, for example). The substrate can be fabricated by chemical vapor deposition (CVD) methods, for example. Defects close to the surface can be introduced during growth (e.g., delta doping) or by ion implantation followed by annealing. Chemical treatment of the surface and longer annealing times can yield shallow defects (about 10 nm to about 20 nm beneath the surface) with coherence times that can be long (e.g., tens to hundreds of milliseconds). MPc thin films are then deposited on top of the substrate; that is, on a surface of the substrate containing optically active electronic spin defects. In some cases, the MPc thin films are deposited on the substrate surface in a vertical-configuration thermal evaporation and deposition system (FIG. 6A). In other cases, the MPc thin films are deposited on the substrate surface in a horizontal-configuration tube furnace system (FIG. 7). In the vertical configuration, MPc powder is loaded in an alumina boat, which is held on a resistive heating unit at the bottom of the chamber. The substrate is placed on top of the chamber, where the temperature can also be independently controlled. The pressure inside the chamber can reach 106 Torr. The MPc powder is thermally evaporated and deposited on the substrate on top. The temperature of evaporating MPc powder is 200° C. to 500° C., and the temperature of the substrate is room temperature (about 20° C.) to 200° C. The deposition rate can be 0.05 nm/s, for example. In the horizontal configuration tube furnace system, the alumina boat loaded with MPc powder is placed at the center of a quartz tube inside the tube furnace. The substrate is placed at about 15 cm to about 20 cm away from the MPc powder. The pressure of the chamber can be pumped down to about 10⁻³ Torr. By heating the furnace, the temperature at the center can be about 300° C. to about 500° C., where the MPc powder is thermally evaporated and deposited on the substrate, where the temperature is about 100° C. to about 200° C.

More specifically, according to some aspects, an example of a method of this disclosure may include providing a first component having a plurality of spin defects such as nitrogen-vacancy centers. The first component can be a layer of diamond or a layer of silicon carbide or other large band-gap materials that allows for stable spin defects, such as binary oxides (ZnO, CeO), other oxides or semiconductors (e.g., silicon). The defects can be interstitial or substitutional defects, or include vacancies, including rare-earth ions, group IV defects, etc. Examples of material substrate and defects include family of rare-earth ions (e.g., Er: CaWoO₄) and P: Si. Regardless of material type, at least a portion of the spin defects are proximal to a first surface of the layer. The method also can include heating a precursor material containing the second component to an elevated temperature sufficient to thermally evaporate an amount of precursor material. Thus, by evaporating the precursor material, a second component can be deposited as a layer on the first surface, where the second component includes at least one metal phthalocyanine (MPc).

As described herein, the method also may include providing a first component, the first component including an NVD, where the NVD may include a material (e.g., diamond or silicon carbide) having a plurality of spin defects (e.g., nitrogen-vacancy centers). At least a portion of the nitrogen-vacancy centers being proximal a first surface of the first component. Providing the first component may be achieved in many ways. For example, such a first component can be provided by forming defects during growth of the first component (e.g., by delta doping of the first component). In another example, the first component can be provided by implanting nitrogen ions followed by annealing. According to some aspects, providing the first component may include selecting conditions sufficient to provide defects extending a certain depth with relation to the first surface. In some non-limiting examples, defects may extend to a depth that is at most about 50 nm with relation to the first surface, optionally at most about 40 nm, optionally at most about 30 nm, optionally at most about 20 nm, optionally at most about 10 nm, and optionally at most about 5 nm. In some non-limiting examples, defects may extend to a depth that is between about 1 and 20 nm with relation to the first surface, optionally between about 1 and 30 nm, and optionally between about 10 and 20 nm.

The method further includes providing a second component on at least a portion of the first surface of the first component via a vertical PVD process or a horizontal PVD process. As used herein, the terminology “vertical PVD process” refers to a process wherein a substrate is provided in a vertical direction relative to a source of material to be deposited thereon. Additionally, as used herein, the term “horizontal PVD process” refers to a process wherein a substrate is provided in a horizontal direction relative to a source of material to be deposited thereon.

FIG. 6A shows an example of a system to implement a vertical PVD process to form hybrid quantum sensors, in accordance with aspects of this disclosure. According to some aspects, the vertical PVD process may be performed in a vacuum chamber 601, which provided with one or more heating elements 602. Example heating elements include, but are not limited to, heating wires, heating belts, and any element or assembly of elements capable of providing the elevated temperature(s) as describe herein.

Vacuum chamber 601 may further be provided with a substrate holder 603 configured to hold a substrate 604. The substrate 604 can form the first component of the hybrid quantum sensor being formed by implementing the vertical PVD process. According to some aspects, the substrate holder 603 includes a substrate holder material capable of being heated to and/or maintained at an elevated temperature during at least a portion of the PVD process. According to some aspects, the substrate holder material may be heated to and/or maintained at an elevated temperature of up to about 300° C., optionally up to about 250° C., and optionally up to about 200° C. during at least a portion of the CVD process. According to some aspects, substrate holder 603 may be heated to and/or maintained at an elevated temperature sufficient to heat and/or maintain substrate 604 at an elevated temperature of between about 20 and 200° C., optionally between about 50 and 150° C., and optionally about 100° C. However, it should be understood that additionally or alternatively, the substrate holder 603 may be maintained at room temperature during at least a portion of the PVD process. As used herein, “room temperature” refers to about 20 to 25° C., optionally about 20° C.

As shown in FIG. 6A, the method also may include providing an amount of precursor material 605 that is used to form a second component of the hybrid quantum sensor being formed. The amount of precursor material can be provided in a tray 208 as is shown in FIG. 6A. It should be understood that the term “tray” as used herein is not particularly limited, and suitable trays include but are not limited to weigh boats, crucibles, flasks, and other vessels having any shape and/or size that can withstand the temperature excursions of the method disclosed herein. In one non-limiting example, tray 608 includes an aluminum crucible. According to some aspects, the precursor material 605 may include a powder, such as a powder of MPc as described herein, or a mixture of paramagnetic MPc such as CuPc with a diamagnetic MPc such as NiPc.

According to some aspects, the method may further include heating the amount of precursor material 605 (e.g., via the heating element 602) to an elevated temperature sufficient to thermally evaporate and deposit at least a portion of the amount of the precursor material 605 on a first surface 606 of the substrate 604. According to some aspects, the elevated temperature may be between about 100° C. and 600° C., optionally between about 150° C. and 550° C., and optionally between about 200° C. and 500° C.

According to some aspects, the method still further includes providing heating apparatus 602 at a pressure sufficient to thermally evaporate and deposit at least a portion of the precursor material 605 in order to form the second component on the first surface 606 of the substrate 604 as described herein. According to some aspects, the pressure within heating apparatus 602 may be between about 10⁻⁵ and 10⁻⁷ Torr, optionally between about 1×10⁻⁶ and 2×10⁻⁶ Torr, and optionally about 10⁻⁶ Torr.

According to some aspects, the deposition of second component onto the first surface 606 of substrate 604 may be performed for a time period sufficient to provide a layer 607 on the first surface 606, the film having a thickness as described herein. The layer 607 embodies or constitutes the second component of the hybrid quantum sensor being formed by implementing the method. It should be understood that the time period may depend on, for example, the deposition rate of precursor material 605 onto the first surface 606 of the substrate 604 and/or the distance between the amount of the precursor material 605 and the first surface 606 of the first component 604.

In some non-limiting examples, the deposition rate may be between about 0.001 and 1 nm/s, optionally between about 0.01 and 0.1 nm/s, and optionally about 0.05 nm/s. In one non-limiting example, the deposition of the second component onto the first surface 606 of substrate 604 may be performed at a 0.05 m/s deposition rate for a time period of about 400 s in order to provide a film having a thickness of about 20 nm.

FIG. 6B shows another example of a system to implement a vertical PVD process to form hybrid quantum sensors, in accordance with aspects of this disclosure. Similar to FIG. 6A, FIG. 6B shows a vacuum chamber 601 in which is provided a substrate holder 603 holding a substrate 604. As described herein, substrate 604 may form the first component of the hybrid quantum sensor being formed by implementing the vertical PVD process. As in FIG. 6A, substrate holder 603 in FIG. 6B may include a substrate holder material capable of being heated to and/or maintained at an elevated temperature during at least a portion of the PVD process as descried in relation to FIG. 6A.

FIG. 6B further shows a plate 609 and a clamp 610 sufficient to hold substrate 604. Plate 609 may include any material sufficient to transfer heat to substrate 604 as described herein, such as stainless steel. According to some aspects, plate 609 and clamp 610 may be such that substrate 604 may be rotated during at least a portion of the method as described herein. Non-limiting examples of rotation speeds include those between 10 and 100 rpm, optionally between 30 and 50 rpm, and optionally about 40 rpm. It should be understood, however, that the disclosure is not necessarily limited to this example. For example, a stainless steel plate 609 and/or clamp 610 may individually be replaced by one or more other components sufficient to hold and/or rotate substrate 604 as described herein.

According to some aspects, vacuum chamber 601 may be sufficient to provide a reduced pressure environment during the vertical PVD process as described herein. In some non-limiting examples, the reduced pressure environment may be an environment having a pressure sufficient to thermally evaporate and deposit at least a portion of a precursor material in order to form the second component on a first surface of the substrate as described herein.

As described in relation to FIG. 6A, the method may include providing an amount of precursor material 605 in tray 208. In one non-limiting example, tray 608 includes an aluminum crucible, as described herein. In other non-limiting examples, tray 208 incudes a crucible formed from quartz and/or alumina. According to some aspects, precursor material 605 may include a powder, such as a powder of MPc as described herein.

According to some aspects, the method may further include heating the amount of precursor material 605 to an elevated temperature sufficient to thermally evaporate and deposit at least a portion of precursor material 605 on a first surface 606 of the substrate 604, as described in relation to FIG. 6A. In particular, FIG. 6B shows a heating element 602 (i.e., a coil proximal an outside surface of tray 208) sufficient to heat precursor material 605 contained in tray 208 to an elevated temperature. It should be understood, however, that the disclosure is not necessarily limited to this example. For example, a heating element other than a coil may be used to heat precursor material 605 contained in tray 208 to the elevated temperature. According to some aspects, the elevated temperature may be between about 100° C. and 600° C., optionally between about 150° C. and 550° C., optionally between about 200° C. and 500° C., and optionally about 410° C. In some non-limiting examples, the elevated temperature may be achieved at a certain ramping rate, for example, at a rate of between about 1 and 10° C. per minute, optionally about 5° C. per minute.

According to some aspects, the method may include heating apparatus 602 at a pressure sufficient to thermally evaporate and deposit at least a portion of precursor material 605 on a first surface 606 of substrate 604 in order to form the second component as described herein. According to some aspects, the deposition of second component onto the first surface 606 of substrate 604 may be performed for a time period sufficient to provide a film on the first surface 606, the film having a thickness as described herein. It should be understood that the time period may depend on, for example, the deposition rate of precursor material 605 onto the first surface 606 of substrate 604 and/or the distance between precursor material 605 in tray 608 and first surface 606 of first component 604.

In some non-limiting examples, the distance between precursor material 605 in tray 608 and first surface 606 may be between about 5 and 50 cm, optionally between about 20 and 40 cm, and optionally about 30 cm.

In some non-limiting examples, the deposition rate may be between about 0.001 and 1 nm/s, optionally between about 0.01 and 0.1 nm/s, and optionally about 0.05 nm/s.

In one non-limiting example, the deposition of the second component onto first surface 606 of substrate 604 may be selected to provide a film having a thickness as described herein. According to some aspects, the thickness of the film may be monitored using thickness monitor 611 throughout the process.

FIG. 6B further shows a shutter 612 and a mask 613 over first surface 606 of the first component 604. Mask 613 may include a material such as stainless steel and may be provided with a window 614 through which precursor material 605 may be deposited onto first surface 606 as described herein. In some non-limiting examples, the method may include providing shutter 612 in a closed position during heating of precursor material 605 and/or substrate 604 as described herein. In this way, precursor material 605 may be prevented from depositing onto first surface 606 until one or more elevated temperature(s) have been reached. The method may further include opening shutter 612 for a time period sufficient to provide a film on first surface 606, the film having a certain thickness as described herein. Once the certain thickness has been obtained, shutter 612 may then be closed to prevent further deposition of precursor material 605 onto first surface 606. In this way, a selected thickness of the film as described herein may be reliably obtained.

FIG. 7 shows another example of a system to implement a horizontal PVD process to form hybrid quantum sensors, in accordance with aspects of this disclosure. For example, FIG. 7 shows a substrate 704 provided in a horizontal direction relative to an amount of precursor material 705 that is used to form a second component of a hybrid quantum sensor as is described herein. The substrate 704 can form the first component of the hybrid quantum sensor being formed by implementing the horizontal PVD process. According to some aspects, the precursor material 705 may include a powder, such as a powder of MPc or a combination of MPcs as described herein.

The horizontal PVD process may be performed in a heating apparatus 701 similar to heating apparatus 602 as described in relation to FIGS. 6A and 6B. FIG. 7 also shows heating elements 702a, 702b, similar to heating element(s) 602 as described in relation to FIGS. 6A and 6B. In some cases, the heating elements 702a and 702b can constitute a conductive coil wound around a section of the apparatus 701.

In this example, the amount of precursor material 705, which may be provided in a tray 708 as described herein, may be heated to a first elevated temperature sufficient to provide a vapor of second component 705 as described herein. According to some aspects, the first elevated temperature may be between about 100° C. and about 700° C., optionally between about 200° C. and about 600° C., and optionally between about 300° C. and about 500° C.

As shown in FIG. 7, an inert gas flow 709 may be provided, for example, along an axis 710 (or, in some cases, a length) of the heating apparatus 701. It should be understood that in this example, the axis 710 (or the length) of heating apparatus 701 is substantially in the horizontal direction as described herein. In this way, first component 704 is provided downstream of vapor of the amount of precursor material 705 that has been evaporated such that inert gas flow 709 may direct the vapor toward the substrate 704. Example inert gasses useful according to the present disclosure include, but are not limited to, argon gas (Ar), nitrogen gas (N), and combinations thereof.

The method may also include heating the substrate 704 to a second temperature sufficient for a layer 707 of the precursor material 705 to be provided on a first surface 706 of the substrate 704, as described herein. According to some aspects, the second temperature may be between about 50° C. and about 250° C., optionally between about 100° C. and about 200° C. According to some aspects, the pressure within heating apparatus 701 may be between about 10⁻² Torr and about 104 Torr, optionally about 10⁻³ Torr.

According to some aspects, a portion of the precursor material 705 may be deposited on the first surface 706 of substrate 704 for a time period sufficient to provide a layer 707 having a thickness as described herein. It should be understood that the time period may depend on, for example, the deposition rate of the precursor material 705 onto the first surface 706 of substrate 704 and/or the distance between the amount of precursor material 705 and the first surface 706 of substrate 704. According to some aspects, the amount of the precursor material 705 may located between about 1 cm and 50 cm from the substrate 704, optionally between about 5 cm and about 30 cm, optionally between about 10 cm and about 25 cm, optionally between about 15 cm and about 20 cm. According to some aspects, the deposition rate of the precursor material 705 onto the first surface 706 of substrate 704 may be between 1 and 250 sccm, optionally between about 50 and 200 sccm.

Although the example methods described herein are described in connection with a substrate 604 and a substrate 704 that form the first component of the hybrid quantum sensors being formed, the disclosure is not limited in that respect. Indeed, the substrate 604 may be formed to include the first component overlaying a planar surface of the substrate 604. For example, the first component can be formed on the planar surface by using evaporation techniques (e.g., PVD, epitaxial techniques (e.g., molecular beam epitaxy (MBE) techniques), sputtering, or other similar deposition techniques. Thus, a slab of a substrate forms the first component, or a layer deposited onto the substrate forms the first component.

FIG. 8 shows a typical optical image of a diamond substrate covered with CuPc thin film. The transparent, blueish surface color indicate a thickness of about 25 nm CuPc thin film.

Some further example aspects are provided below.

Clause 1. A device comprising: a first layer of a material having multiple optically active defect centers having electronic spins; and a second layer overlaying the first layer and forming a planar interface with the first layer, wherein the second layer comprises at least one metal phthalocyanine or one or more metallorganic molecules.

Clause 2. The device of clause 1, wherein the material is selected from a group comprising diamond, silicon carbide, an oxide, and a semiconductor.

Clause 3. The device of clause 1 or 2, wherein a first metal phthalocyanine of the at least one metal phthalocyanine comprises a transition metal.

Clause 4. The device of any of clauses 1-3, wherein a first metal phthalocyanine of the at least one metal phthalocyanine comprises CuPc.

Clause 5. The device of any of clauses 1-4, wherein a second metal phthalocyanine of the at least one metal phthalocyanine comprises NiPc.

Clause 6. The device of any of clauses 1-5, wherein the second layer has a thickness in a range from about 1 nm to about 200 nm.

Clause 7. The device of clause 6, wherein the thickness is between about 20 and 30 nm.

Clause 8. The device of clause 6, wherein the thickness is about 25 nm.

Clause 9. The device of any of clauses 1-8, wherein the second layer has a roughness between about 0.5 to 1.5 nm.

Clause 10. A method comprising: providing a first component having a plurality of optically active electronic spin defects, wherein at least a portion of the optically active electronic spin defects are proximal to a first surface of the first component; and depositing a layer of a material comprising at least one metal phthalocyanine onto the first surface to provide a second component overlaying the first component and forming a planar interface with the first surface.

Clause 11. The method of clause 10, wherein the first component comprises a layer of diamond, a layer of silicon carbide, a layer of an oxide, or a layer of a semiconductor.

Clause 12. The method of clause 10 or 11, wherein the depositing comprises evaporating an amount of the material, wherein the amount of the material is placed in a tray provided a certain distance from a substrate comprising the first component.

Clause 13. The method of clause 12, wherein the distance is between about 20 and 40 cm.

Clause 14. The method of any of clauses 10-13, wherein evaporating the amount of material comprises heating the first component to a first elevated temperature.

Clause 15. The method of clause 14, wherein the first elevated temperature is between about 20 and 200° C.

Clause 16. The method of any of clauses 10-15, wherein evaporating the amount of material comprises heating the amount of material to a second elevated temperature.

Clause 17. The method of clause 16, wherein the second elevated temperature is between about 200° C. and 500° C.

Clause 18. The method of any of clauses 10-17, wherein evaporating the amount of material comprises providing the first component and the material in a reduced pressure environment.

Clause 19. The method of any of clauses 10-18, wherein the at least one metal phthalocyanine comprises CuPc.

Clause 20. The method of any of clauses 10-19, wherein the at least one metal phthalocyanine comprises NiPc.

Clause 21. A method comprising: applying a static magnetic field to a quantum sensor device having a nitrogen-vacancy (NV) defect center and a layer including at least one paramagnetic metal phthalocyanine, the NV defect center forming a qubit in response to the static magnetic field; performing an excitation stage on a quantum sensor device, the excitation stage including: shining first visible light on the quantum sensor device; applying a sequence of microwave pulses including: applying a first microwave pulse at a first time to generate a superposition of a first eigenstate of the qubit and a second eigenstate of the qubit; applying a second microwave pulse at a second time after the first time to cause an inversion the first eigenstate into the second eigenstate and an inversion of the second eigenstate into the first eigenstate; applying a third microwave pulse at a third time after the second time to map a degree of coherence of the superposition to a population of the qubit; performing a detection stage including: shining second visible light on the quantum sensor device; and detecting light emitted from the quantum sensor device.

Clause 22. The method of clause 21, further comprising determining a coherence time of the qubit by, at least partially, monitoring a change in intensity of the detected light emitted from the quantum sensor device after repeating, a defined number of times, the performing the excitation stage and the performing the detection stage.

Clause 23. The method of clause 21 or 22, wherein the applying the first microwave pulse causes a first p/2 rotation of the superposition.

Clause 24. The method of clause 23, wherein the applying the second microwave pulse causes a p rotation of the superposition, and wherein a difference between the second time and the first time corresponds to half a time interval corresponding to a complete evolution of the first p/2 rotation.

Clause 25. The method of clause 24, wherein the applying the third microwave pulse causes a second p/2 rotation of the superposition, and wherein a difference between the third time and the second time corresponds to second half the time interval corresponding to the complete evolution of the first p/2 rotation.

Clause 26. The method of any of clauses 21-25, wherein the applying the static magnetic field comprises applying the static magnetic field along a defined crystallographic direction of the quantum sensor device.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Herein, the recitation of numerical ranges by endpoints (e.g. between about 50:1 and 1:1, between about 100 and 500° C., between about 1 minute and 60 minutes) include all numbers subsumed within that range, for example, between about 1 minute and 60 minutes includes 21, 22, 23, and 24 minutes as endpoints within the specified range. Thus, for example, ranges 22-36, 25-32, 23-29, etc. are also ranges with endpoints subsumed within the range 1-60 depending on the starting materials used, temperature, specific applications, specific embodiments, or limitations of the claims if needed. The Examples and methods disclosed herein demonstrate the recited ranges subsume every point within the ranges because different synthetic products result from changing one or more reaction parameters. Further, the methods and Examples disclosed herein describe various aspects of the disclosed ranges and the effects if the ranges are changed individually or in combination with other recited ranges.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

As used herein, the term “about” and “approximately” are defined to being close to as understood by one of ordinary skill in the art. In one non-limiting embodiment, the term “about” and “approximately” are defined to be within 10%, preferably within 5%, more preferably within 1%, and most preferably within 0.5%.

### EXAMPLES

### Example I: Synthesis of Hybrid Quantum Sensor

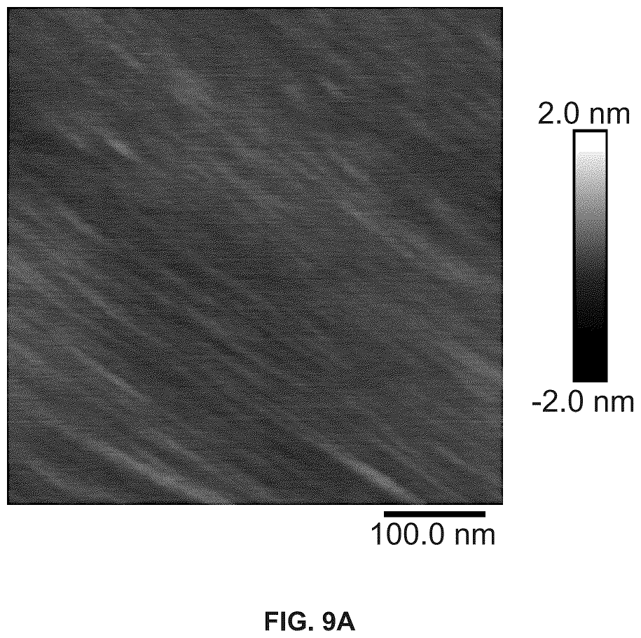

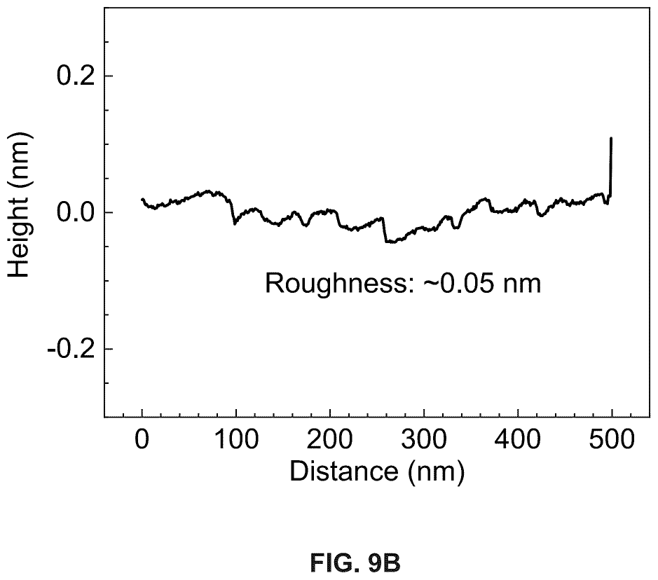

First, a diamond substrate was mounted onto a stainless steel plate. FIG. 9A shows an atomic force microscopy (AFM) image of the diamond surface, and FIG. 9B shows the AFM topography profile of the diamond surface. As shown in FIG. 9B, the surface roughness was approximately 0.05 nm.

A stainless steel film mask with an open window was then provided over the diamond substrate, and the diamond substrate, the stainless steel plate, and the stainless steel film mask were mounted onto a holder in an evaporator chamber. The evaporation chamber was further provided with a CuPc powder loaded in a crucible having a heating coil around an outside surface thereof. The distance between the crucible and the diamond substrate was approximately 30 cm.

The evaporation chamber was then evacuated to a base vacuum of 1-2×10⁻⁶ Torr pressure. The crucible with CuPc powder was heated to approximately 410° C. with a ramping rate of ˜5° C./min (1-10° C./min) as the diamond substrate was simultaneously heated to approximately 100° C. by the holder. A shutter between the CuPc powder and the diamond substrate was kept closed until the CuPc powder and the diamond substrate were heated to the selected temperatures. The shutter was then opened to allow deposition of CuPc on the diamond substrate. During deposition, the diamond substrate was rotated at the speed of ˜40 rpm, and the thickness of the resulting CuPc film was monitored using a thickness monitor. Once the thickness reached approximately 25 nm, the shutter was closed to prevent addition CuPc deposition, and both of the heating coil and the holder were shut off to allow for natural cooling of the diamond substrate and CuPc film to room temperature.

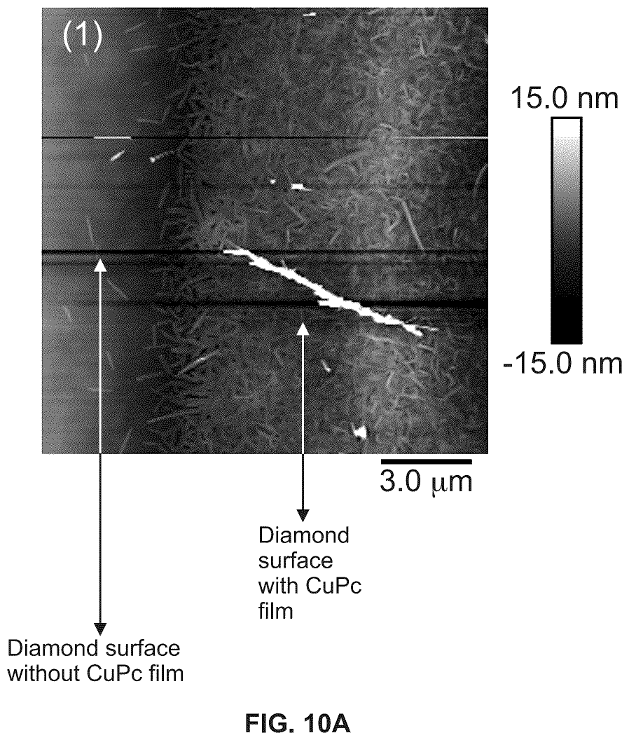

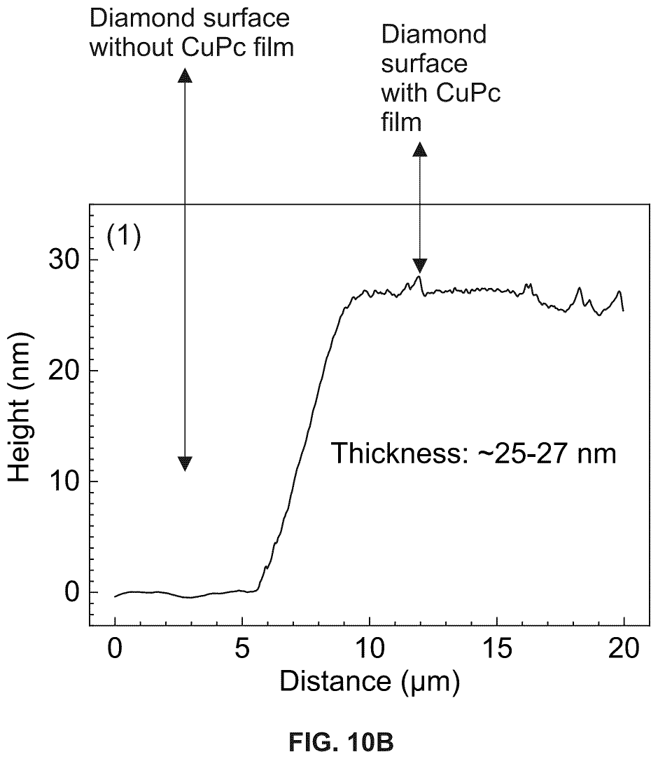

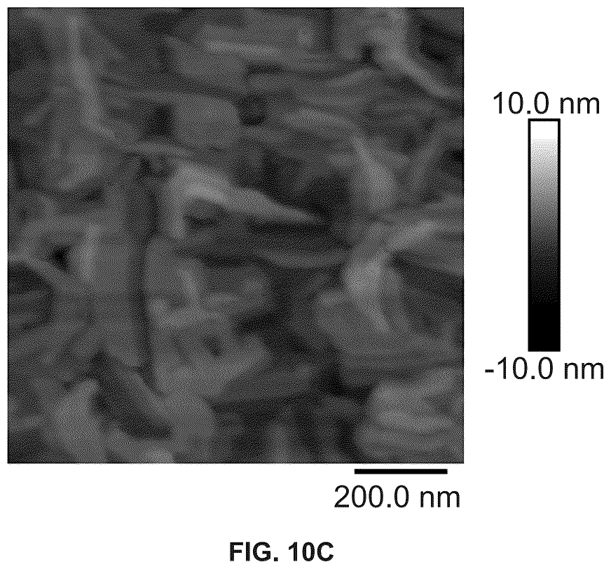

FIG. 10A shows an AFM image of the diamond surface after CuPc deposition. In particular, FIG. 10A shows a portion of the diamond surface having the CuPc film thereon (i.e., the portion of the diamond surface proximal the open window during deposition) and a portion of the diamond surface without the CuPc film (i.e., the portion of the diamond surface not exposed through the open window during deposition). FIG. 10B shows the AFM topography profile of the diamond surface shown in FIG. 10A. As shown in FIG. 10B, the surface roughness of the CuPc film on the diamond substrate was approximately 0.8 nm. FIG. 10C shows an enlarged view of the AFM image shown in FIG. 10A.

### Example II: Performance of Hybrid Quantum Sensor

The hybrid quantum sensor prepared according to Example 1 was mounted on a piezo stage, and excitation at 532 nm was provided by a diode-pumped laser. Fluorescence in the phonon sideband (650 to 800 nm) was collected by a large NA oil immersion objective. A 715 nm short passfilter provided isolation from the fluorescence coming from the CuPc film. The fluorescence photons were collected by a single-photon counting module. As the NVs separated, single NV centers were imaged within the confocal microscope spatial resolution. Laser pulses for polarization and detection were generated by an acousto-optic modulator with nanoseconds rise time.

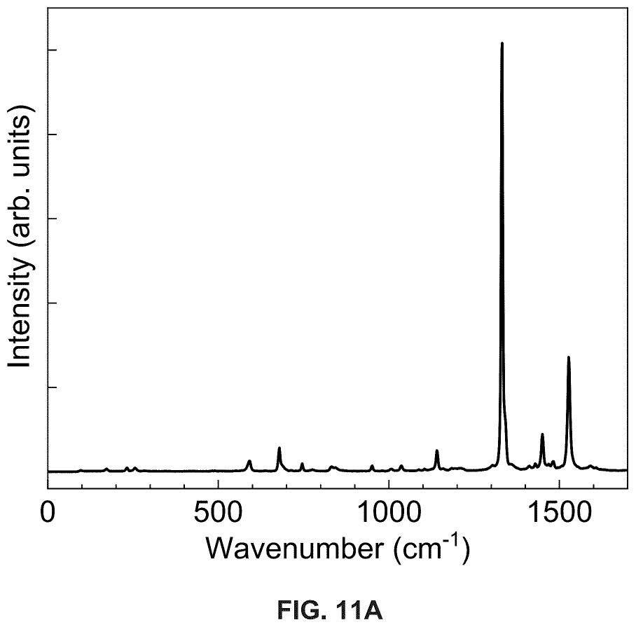

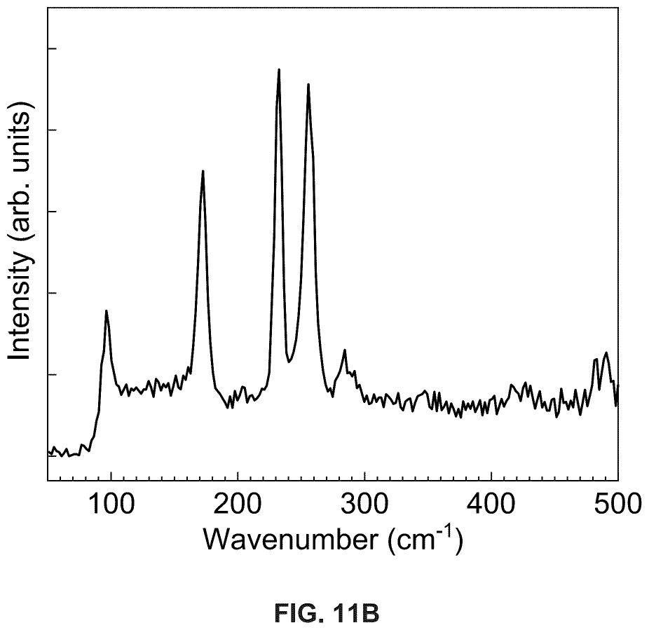

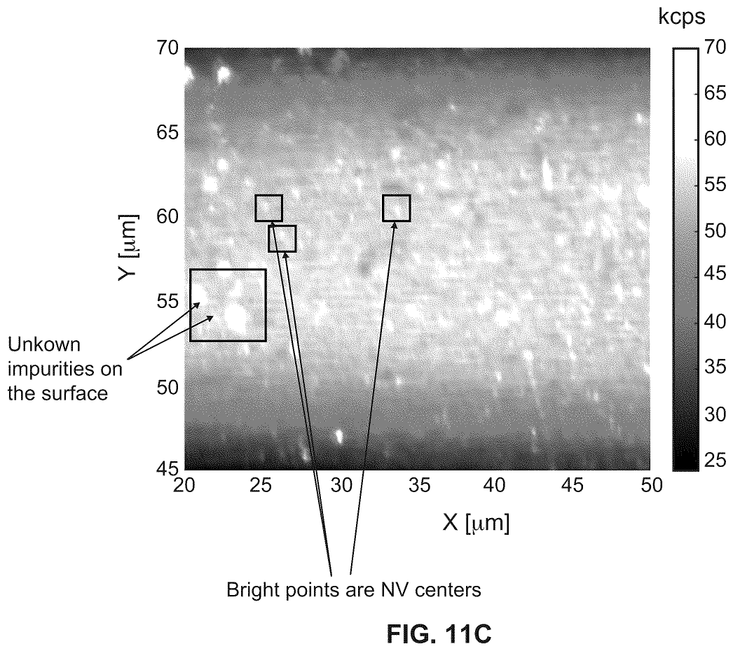

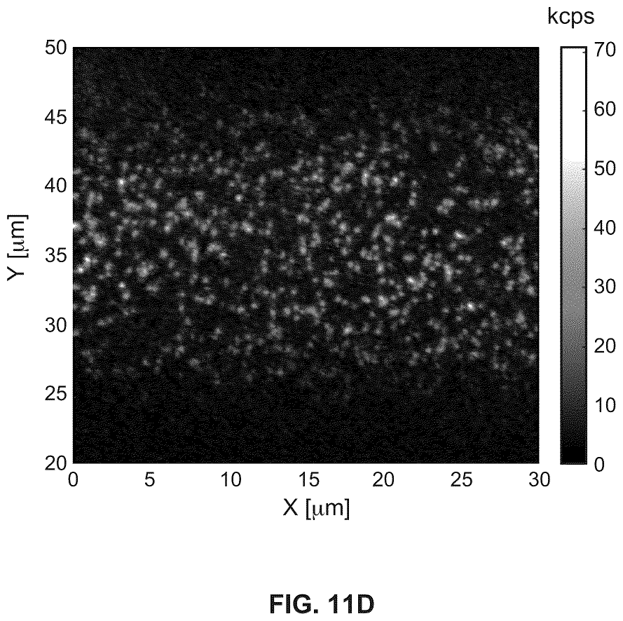

FIG. 11A shows the Raman spectrum of the hybrid quantum sensor with 532 nm laser excitation. FIG. 11B shows an enlarged view of the spectrum of FIG. 11A from 50 to 500 cm⁻¹, including signal Raman peaks of α-phase CuPc. FIG. 11C shows a confocal image of the hybrid quantum sensor under 0.7 mW laser illumination. Despite background light from the CuPc film, NV centers are still visible. FIG. 11D shows a confocal image of a diamond sample without CuPc film under 0.7 mW laser illumination. Each bright spot is a NV center

A signal generator was then used to provide microwave fields to coherently manipulate the qubit. An arbitrary waveform generator was employed to shape microwave pulses with the help of an I/Q mixer and to time the experimental sequence, including laser pulses and readouts via a data acquisition system (DAQ). Microwaves were amplified and subsequently delivered to the sample by a microwave stripline mounted on a printed circuit board, over which the diamond was mounted.

A static magnetic field was applied by a permanent magnet mounted on a rotation stage and attached to a three-axis translation stage. This arrangement enabled the adjustment of the magnetic field angle with respect to the sample. The magnetic field was aligned along a [111] axis by maximizing the Zeeman splitting in a CW ESR spectrum.

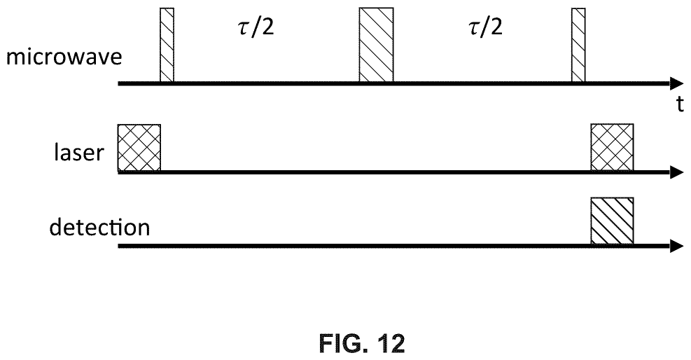

T2 coherence times were measured using a spin echo pulse sequence, as shown in FIG. 12.

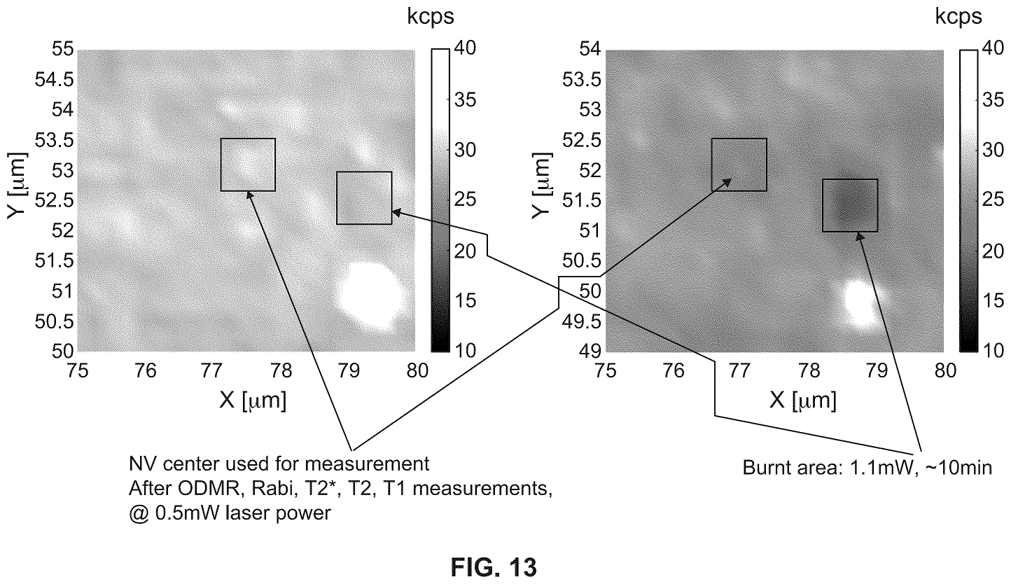

After optical illumination, a single NV was polarized in its mₛ=0 state. An on-resonance microwave pulse of calibrated duration to engineer a pi/2 rotation created an equal superposition of the mₛ=0 and mₛ=−1 eigenstates that evolves under the effects of magnetic field noise, in part generated by the CuPc. At half the evolution time, another microwave pulse induced a pi rotation, effectively inverting the 0 and −1 eigenstate. Static noise was thus refocused, increasing the coherence time and allowing detection of time-dependent noise. At the end of the evolution, another pi/2 pulse mapped the remaining coherence to population, which was measured by optical illumination, as shown in FIG. 13.

Each data point was repeated 500000 times, and the whole experiment was then repeated ten times (recalibrating the NV position if needed). While this number of repetitions was slightly higher than similar experiments without a CuPc film due to an increase in background noise, it still corresponds to only about five microseconds of laser illumination for each repetition.

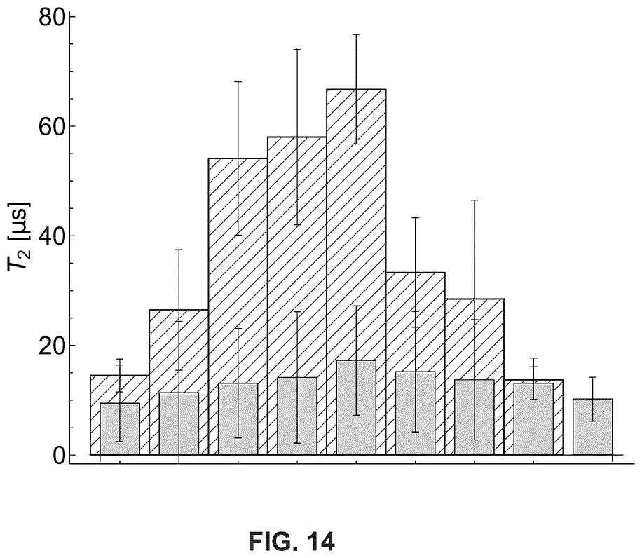

The resulting decay curves were fitted to a single exponential to extract the decay time T2, as shown in FIG. 14. As shown in FIG. 14, nine NVs (red) are under the CuPC layer, and eight NVs (blue) are in a CuPc-free diamond region on the diamond edge. The measured T2 times clearly show that adding the CuPC film decreased the NV coherence times. It was thus determined that the NV can detect the CuPC presence due to their magnetic coupling.

What is claimed is:

1. A device comprising:
a first layer of a material having multiple optically active defect centers having electronic spins; and
a second layer overlaying the first layer and forming a planar interface with the first layer, wherein the second layer comprises at least one metal phthalocyanine or one or more metallorganic molecules.

2. The device of claim 1, wherein the material is selected from a group comprising diamond, silicon carbide, an oxide, and a semiconductor.

3. The device of claim 1, wherein a first metal phthalocyanine of the at least one metal phthalocyanine comprises a transition metal.

4. The device of claim 1, wherein a first metal phthalocyanine of the at least one metal phthalocyanine comprises CuPc.

5. The device of claim 4, wherein a second metal phthalocyanine of the at least one metal phthalocyanine comprises NiPc.

6. The device of claim 1, wherein the second layer has a thickness in a range from about 1 nm to about 200 nm.

7. The device of claim 6, wherein the thickness is between about 20 and 30 nm.

8. The device of claim 6, wherein the thickness is about 25 nm.

9. The device of claim 1, wherein the second layer has a roughness between about 0.5 to 1.5 nm.

10. A method comprising:
providing a first component having a plurality of optically active electronic spin defects, wherein at least a portion of the optically active electronic spin defects are proximal to a first surface of the first component; and
depositing a layer of a material comprising at least one metal phthalocyanine onto the first surface to provide a second component overlaying the first component and forming a planar interface with the first surface.

11. The method of claim 10, wherein the first component comprises a layer of diamond, a layer of silicon carbide, a layer of an oxide, or a layer of a semiconductor.

12. The method of claim 10, wherein the depositing comprises evaporating an amount of the material, wherein the amount of the material is placed in a tray provided a certain distance from a substrate comprising the first component.

13. The method of claim 12, wherein the distance is between about 20 and 40 cm.

14. The method of claim 12, wherein evaporating the amount of material comprises heating the first component to a first elevated temperature.

15. The method of claim 14, wherein the first elevated temperature is between about 20 and 200° C.

16. The method of claim 12, wherein evaporating the amount of material comprises heating the amount of material to a second elevated temperature.

17. The method of claim 16, wherein the second elevated temperature is between about 200° C. and 500° C.

18. The method of claim 12, wherein evaporating the amount of material comprises providing the first component and the material in a reduced pressure environment.

19. The method of claim 10, wherein the at least one metal phthalocyanine comprises CuPc.

20. The method of claim 10, wherein the at least one metal phthalocyanine comprises NiPc.

21. A method comprising:
applying a static magnetic field to a quantum sensor device having a nitrogen-vacancy (NV) defect center and a layer including at least one paramagnetic metal phthalocyanine, the NV defect center forming a qubit in response to the static magnetic field;
performing an excitation stage on a quantum sensor device, the excitation stage including:
shining first visible light on the quantum sensor device;
applying a sequence of microwave pulses including:
applying a first microwave pulse at a first time to generate a superposition of a first eigenstate of the qubit and a second eigenstate of the qubit;
applying a second microwave pulse at a second time after the first time to cause an inversion the first eigenstate into the second eigenstate and an inversion of the second eigenstate into the first eigenstate;
applying a third microwave pulse at a third time after the second time to map a degree of coherence of the superposition to a population of the qubit;
performing a detection stage including:
shining second visible light on the quantum sensor device; and
detecting light emitted from the quantum sensor device.

22. The method of claim 21, further comprising determining a coherence time of the qubit by, at least partially, monitoring a change in intensity of the detected light emitted from the quantum sensor device after repeating, a defined number of times, the performing the excitation stage and the performing the detection stage.

23. The method of claim 21, wherein the applying the first microwave pulse causes a first p/2 rotation of the superposition.

24. The method of claim 23, wherein the applying the second microwave pulse causes a p rotation of the superposition, and wherein a difference between the second time and the first time corresponds to half a time interval corresponding to a complete evolution of the first p/2 rotation.

25. The method of claim 24, wherein the applying the third microwave pulse causes a second p/2 rotation of the superposition, and wherein a difference between the third time and the second time corresponds to second half the time interval corresponding to the complete evolution of the first p/2 rotation.

26. The method of claim 21, wherein the applying the static magnetic field comprises applying the static magnetic field along a defined crystallographic direction of the quantum sensor device.
